(19) United States
(12) Patent Application Publication
(10) Pub. No.: US 2011/0236713 A1
(43) Pub. Date: Sep. 29, 2011

(54) FUNCTIONALLY GRADED MATERIAL SHAPE AND METHOD FOR PRODUCING SUCH A SHAPE

(75) Inventors: Mohamed Radwan, Stockholm (SE); Katarina Flodstrom, Solna (SE); Saeid Esmaeilzadeh, Stockholm (SE)

(73) Assignee: Diamorph AB, Stockholm (SE)

(21) Appl. No.: 13/026,680

(22) Filed: Feb. 14, 2011

Related U.S. Application Data
(60) Provisional application No. 61/317,858, filed on Mar. 26, 2010.

(30) Foreign Application Priority Data
Mar. 26, 2010 (SE) 1050289-6

(51) Int. Cl. B32B 15/04; B22F 3/105; B82Y 30/00

(52) U.S. Cl. 428/610; 428/448; 419/1; 977/776; 977/777

(57) ABSTRACT

The invention relates to a functionally graded material shape (1) where a first material (M1) is fused with a second material (M2) through sintering and a method of production of said functionally graded material shape (1). Said first material (M1) has a first coefficient of thermal expansion (α1) and said second material (M2) has a second coefficient of thermal expansion (α2), differing from the first coefficient of thermal expansion (α1). The invention is characterized in that the shape (1) further comprises a third material (M3) adapted to, together with M1 and M2, create an intermediate composite material phase intermixed between the first and the second materials (M1, M2). Said third material (M3) has a coefficient of thermal expansion (α3) intermediate between the first coefficient of thermal expansion (α1) of the first material (M1) and the second coefficient of thermal expansion (α2) of the second material (M2).

### TECHNICAL FIELD

The present invention relates to a method for producing a stainless steel/alumina functionally graded material shape without material defects, particularly by the spark plasma sintering technique (SPS). A stable joining of an aluminium oxide ceramic to stainless steel will improve the thermal properties, the wear resistance and introduce an electrically insulating behavior to the alloy.

### BACKGROUND ART

A functionally graded material (FGM) is a material design concept which provides a solution to relieve the residual thermal stresses and to incorporate incompatible properties of two dissimilar materials, such as the heat, the wear, and the oxidation resistance of a refractory ceramic with the high toughness, the high strength, and the machinability of a metal by placing graded composite interlayers of the two materials between the pure layers.

Generally, a metal/ceramic FGM system with a graded region consists of several composite layers, there is a gradual variation of the microstructure with the composition change. The matrix is replaced gradually from metal to ceramic, and the microstructure profile varies concurrently from (i) a pure metal, (ii) a metal-rich region (the ceramic particles are dispersed in metal matrices), (iii) intertwined composites (networks of metal and ceramic phases with comparable volume fractions), (iv) a ceramic-rich region (the metal matrix diminishes and turns into discrete phases or particles in ceramic matrices), to finally (v) a pure ceramic. This gradient in the composition-microstructure-properties along the FGM is the key for its stability and performance.

Throughout the FGM, the fracture behavior will also change from a ductile to a brittle mode with the gradual variation of the matrix from ductile metal phase to brittle ceramic phase. On cooling a FGM with a linear compositional profile, the common thermal stresses that arise due to the thermal expansion mismatches are the in-plane radial stresses (parallel to the interfaces) and the axial stresses through the thicknesses (normal to the interfaces). If α_{ceromic}<αₘₑₜₐₗ, where α is the thermal expansion coefficient, the states of the in-plane stresses will be tensile in the base metal and compressive in the top ceramic composites. On the contrary, the axial stresses will be compressive in the metal region and tensile in the ceramic side. The material in the metal-rich and intertwined regions can withstand the residual thermal stresses by a plastic deformation mechanism. However, ceramics are brittle and weak in tension, so the ceramic-rich region will be the critical part and micro-cracking may develop in the matrix if the levels of residual tensile stresses exceed its bending strength.

The magnitudes of residual stresses throughout the FGM will depend on the extent of thermal strains that occur both on a microstructure-level (between the matrix-particulates) and on a macrostructure-level (at the interfaces between adjacent layers) during the cooling as described by the following basic equation:

σ=EΔαΔT (1)

where σ is the residual thermal stress (MPa), E is the Young's modulus (MPa), Δα the thermal expansion mismatch (/° C.), and ΔT is the difference between the sintering and room temperature (° C.).

According to Eq. 1, the best solution to reduce the residual thermal stresses, σ, lies in minimizing the thermal expansion mismatches, Δα, and the sintering temperature, meanwhile improving the mechanical toughness of the matrices especially in the composition range where the maximum thermal stresses arise.

FGMs can be prepared through different techniques such as conventional powder metallurgy processing, vapour deposition and sintering techniques. The spark plasma sintering method (SPS), also referred to as for example field assisted sintering technique (FAST), is a powerful sintering technique which allows very rapid heating under high mechanical pressures. This process, hereafter referred to as SPS, has proved to be very well suited for the production of functionally graded materials. Without wishing to be bound by any particular theory, it is believed that the very rapid sintering enhances the particles bonding and densification meanwhile limits the possibility of undesired reactions in the materials. It also gives advantages such as no need of binders in the powders and a controlled shrinkage of the material during the compaction. Further, the possibility to rapidly change the temperature and pressure makes it easier to tailor the microstructure of the material and to optimize the sintering conditions compared to conventional compaction techniques.

The U.S. Pat. No. 7,393,559B2 describes the production of a FGM net shaped body with FAST/SPS where the two different materials included are a metal or a metal alloy in combination with a ceramic such as an oxide, nitride or carbide, or another metal or metal alloy.

Stainless steel type 316 (SUS316) is an austenitic chromium-nickel-molybdenum stainless steel. SUS316L is a similar alloy but with extra-low carbon content. These are important engineering alloys because of their good elevated temperature strengths and high corrosion resistances. Alumina ceramics (Al₂O₃) have excellent heat and corrosion resistance with high hardness. Joining of SUS316L and Al₂O₃ is of great interest in structural components or shapes for thermal and wear resistance applications.

The thermal expansion coefficient of Al₂O₃ (α_{Al2O}≈6×10⁻⁶/° C.) is much lower than that of SUS316L (α_{SUS316L}≈18×10⁻⁶/° C.). A large difference in thermal expansion coefficients generates complex thermal residual stresses at the joint interface during cooling from the fabrication temperature. A large difference in thermal expansion coefficient is by a person skilled in the art considered to be in the range of about 7×10⁻⁶/C.° to about 10×10⁻⁶/C.°, as defined in for example WO 2007/144731A1. These stresses can cause various material failures such as a cracking within the ceramic part, a plastic deformation in the metal and/or an interfacial decohesion.

The fabrication of a functionally graded material for the specific system stainless steel/alumina was theoretically analyzed by M. Grujicic et al. “Optimization of 316 Stainless Steel/Alumina Functionally Graded Materials for Reduction of Damage Induced by Thermal Residual Stresses”, Materials Science and Engineering A, 252, 1998, 117-132.

Though both the plastic deformation in the SUS316-rich layers and the interface decohesion can be greatly minimized by inserting optimized graded composite interlayers, the formation of cracks in the Al₂O₃ and the Al₂O₃-rich layers could not be avoided. The main difficulty is that the levels of the calculated residual tensile stresses in the virtual FGM specimens remained so close to the range of the bending strength of the dense Al₂O₃ ceramics (250-275 MPa). Thus, there is still a need for a method to fabricate stainless steel/alumina FGMs without cracking.

### SUMMARY OF INVENTION

An object of the present invention is to create a functionally graded material, as claimed in claim 1, preferably a crack-free functionally graded material shape. A further object of the invention is to create a method for producing a crack-free functionally graded material shape.

The term shape shall be read as any component having any type of shape and form and which is possible to produce with the FGM concept, for example a pellet in the shape of a cylinder, sphere, ring, polygon or cone. Other types of shapes are also possible.

In the functionally graded material shape according to claim 1, a first material is fused with a second material through sintering. Said first material has a first coefficient of thermal expansion and said second material has a second coefficient of thermal expansion, differing from the first coefficient of thermal expansion. The invention is characterized in that the shape further comprises a third material adapted to create an intermediate composite material phase intermixed between the first and the second materials. Said third material has a coefficient of thermal expansion intermediate between the first coefficient of thermal expansion of the first material and the second coefficient of thermal expansion of the second material.

The thermal expansion mismatch or difference between the first and the second materials is large, preferably up to 12×10⁻⁶/° C.

By intermixing a third material with an intermediate coefficient of thermal expansion in the first and second material, the plastic deformation in the first material and the interface decohesion can be greatly minimized. The volume of the third material reduces the unit volume of the second material and can provide internal restrains that significantly reduces the magnitude of the volume shrinkage during the cooling. The third material also works as tough blocking aggregates which can strengthen the second material and impede the initiation of thermally induced micro-cracks.

In a preferred embodiment the first material is a metal or metal alloy and the second material is preferably a ceramic material but can also be a metal or metal alloy. In another preferred embodiment the third material is a metal or a ceramic additive.

The third material may be chosen from any of the materials zirconia, chromium, platinum or titanium.

A metal or metal alloy material has the required high toughness, high strength, and machinability of a functionally graded material shape and a ceramic material has the required heat, wear, and oxidation resistance of the same.

In a preferred embodiment of the invention the first, second and third materials sinter at approximately the same sintering temperature, or sinter at approximately the same sintering unit settings.

By using materials with approximately the same sintering temperatures the sintering process is simplified and a regular, normally cylindrical, sintering mould, here referred to as die, can be used for sintering. But if a non-cylindrical die with different diameters at different locations, such as a conical, is used it is also possible to use materials with sintering temperature differences of up to 300° C. and still use the same sintering unit settings.

In one embodiment of the invention at least one of the materials has a grain dimension of such a small dimension compared to standard powders of micrometer size that the sintering temperature of the material is influenced. Preferably, a nano-sized powder is used in at least one of the materials.

Using a powder with a smaller dimension enables making the sintering at a lower sintering temperature. By selecting different grain dimension of the different materials, their sintering temperature may be optimized in relation to each other in order to further simplify the sintering process.

In a further preferred embodiment the first material is one of stainless steel, nickel, a nickel alloy or a copper alloy and the second material is a ceramic material. Preferably, the first material is one of stainless steel SUS 316/316L, SUS 304/304L, SUS 310/310S, SUS 405, SUS 420, Duplex stainless steel 2205, nickel, nickel alloy or copper alloy and the second material is aluminium oxide (alumina).

A method for producing the functionally graded material shape is also disclosed. The method is characterized in that the production method is spark plasma sintering (SPS).

By using spark plasma sintering it is possible to rapidly change the temperature and pressure, thus making it easier to tailor the microstructure of the material and to optimize the sintering conditions.

A method for producing a FGM having one surface comprising up to 100% of a first material and a second surface comprising up to 100% of a second material is also disclosed. The method comprises the steps: (i) selecting the first material and the second material with a first and second coefficient of thermal expansion different from each other, (ii) adding a determined amount of a third material with an intermediate coefficient of thermal expansion intermixing with the first and the second material and creating an intermediate phase comprising the invention of the functionally graded material shape, (iii) adding at least one interlayer of the intermediate phase material between the first surface and the second surface creating an intermediate graded composite region, and (iv) sintering the whole shape using the spark plasma sintering (SPS) technology.

By intermixing a third material with different properties with a first tough material and second wear resistant material, the above method is producing a crack-free FGM where it is possible to join materials with a large mismatch in coefficient of thermal expansion.

In another embodiment according to the method, the intermediate graded composite region has several interlayers essentially consisting of different mixtures of the first, second and third materials.

In this embodiment the intermediate graded composite region of the FGM consists of several composite layers, preferably loaded layer by layer into the die, where there is a gradual variation of the microstructure with the composition change. The matrix is replaced gradually from the first to the second material. This gradient in the composition-microstructure-properties along the FGM is the key for its stability and performance.

In a further embodiment the three materials are delivered continuously into a die in which the material is sintered creating at least one interlayer with gradual variation in composition, smoothly or stepwisely, throughout the FGM shape consisting of different mixtures of the first, second and third materials.

In this other embodiment, instead of using pre-prepared interlayers of a mix between the first, second and third material the fine graded powders of the three materials are delivered continuously into the die in which the material is sintered forming the shape. Preferably, the amount of powder delivered of each material is automatic or manually controlled in order to create the optimum gradual variation of the microstructure in the one interlayer forming the shape.

In one preferred embodiment, the compositions throughout the interlayer or interlayers are determined using an equation where the local volume fraction of the first material, Vᵢ, in each interlayer is calculated as follows:

$${V}_{i} = [ 1 - {( \frac{i}{n + 1} )}^{P} ] \qquad ( 2 )$$

where i is the number of an interlayer, n is the total number of interlayers, and P is a material concentration exponent.

In yet another embodiment the third material is added in at least one of the interlayers in a certain ratio of the volume fraction of the second material. If more than nine interlayers are used, preferably between 15 and 25, more specifically 19, the first material content changes linearly throughout the graded interlayers with approximately 5 percentages per volume per interlayer and the third material is added as a toughening phase in a ratio of approximately 45 percentages per volume of the second material volume.

By using the above mentioned method of determining the compositions throughout the interlayer or interlayers the properties of the FGM shape are optimized.

In a preferred embodiment the sintering takes place at a temperature of 1000-1200° C., preferably 1100° C., under a pressure of 50-100 MPa, preferably 75 MPa, for a holding time of about 10 to about 40 min, preferably about 20 to about 30 min, by spark plasma sintering.

The above mentioned parameters are a preferred embodiment. However, it is obvious that the temperature range can be extended if the first material is changed from stainless steel to nickel or chromium. Further, the holding time can be shorter if the pressure is higher.

In one embodiment the at least one of the composite interlayers comprises a first material of metal or metal alloy, a toughening additive and a ceramic, creating a tri-phase composite. Preferably the composite interlayers are composed of a first material of a metal or metal alloy, chosen from one of stainless steel SUS 316/316L, SUS 304/304L, SUS 310/310S, SUS 405, SUS 420. Duplex stainless steel 2205, nickel, nickel alloy or copper alloy, a second material of a ceramic, chosen from one of alumina, molybdenum disilicide, tungsten carbide, and a third material as a toughening-phase additive, chosen from one of zirconia(3Y), chromium, platinum or titanium.

### BRIEF DESCRIPTION OF DRAWINGS

The invention is now described, by way of example, with reference to the accompanying drawings, in which:

FIG. 1 is a drawing of a chart of Young's modulus plotted against the linear thermal expansion coefficient,

FIG. 2 is a schematic drawing of the FGM geometry,

FIG. 3 are optical micrographs (top) and corresponding schematic morphologies (bottom) of: (a) the 30 vol % SUS316L-70 vol % Al₂O₃ composite interlayer, and (b) the 30 vol % SUS316L-38.5 vol % Al₂O₃-31.5 vol % ZrO₂(3Y) composite interlayer and

FIG. 4 are optical photographs showing: (a) the bulk dense FGM, and (b) the multilayers structure.

### DESCRIPTION OF EMBODIMENTS

The invention will now be described in more detail in respect of embodiments and in reference to the accompanying drawings. All examples herein should be seen as part of the general description and therefore possible to combine in any way in general terms. Again, individual features of the various embodiments and methods may be combined or exchanged unless such combination or exchange is clearly contradictory to the overall function of the functionally graded material shape or its method of production.

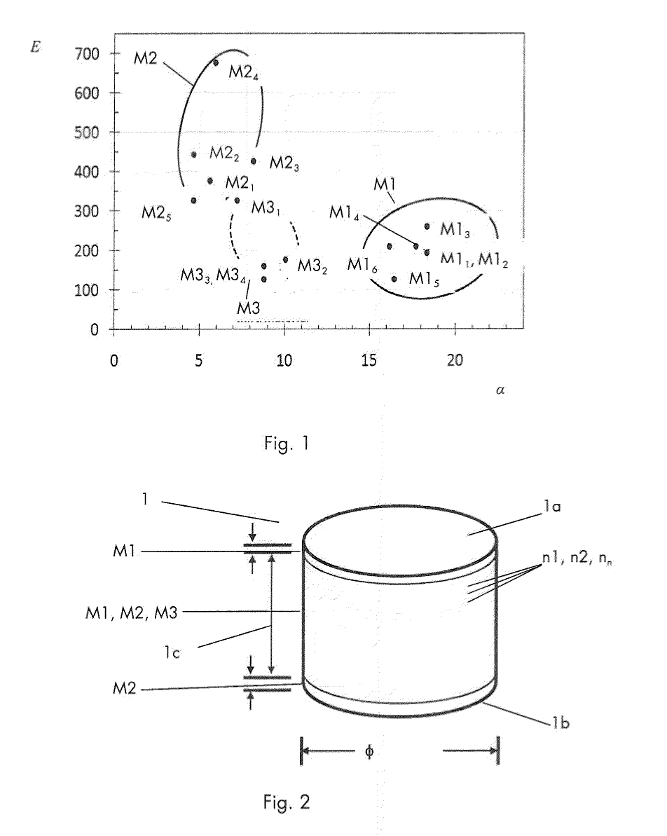

In FIG. 1 a drawing of a chart of Young's modulus E in GPa plotted against the linear thermal expansion coefficient a in 10⁻⁶/° C. is shown with contours showing examples for the first M1, second M2, and third M3 materials of the preferred embodiment of the invention. In the preferred embodiments of the invention the first material M1 is one of stainless steel M1₁, M1₂, M1₃, M1₆, nickel M1₄, or copper alloy M1₅ and the second material M2 is preferably a ceramic material, but can in some cases be a metal or metal alloy, one or more of alumina M2₁, silicon carbide M2₂, molybdenum disilicide M2₃, tungsten carbide M2₄, or molybdenum M2₅. Preferably, the first material is one of stainless steel SUS316/316L (M1₃), SUS304 (M1₁), SUS310 (M1₂), nickel (M1₄), or copper alloy (M1₅) and the second material is aluminum oxide (M2₁). Further, the third material M3 is a metal or a ceramic additive M3₁, M3₂, M3₃, or M3₄, preferably chosen from any of the materials zirconia (M3₂), chromium (M3₁), platinum (M3₃) or titanium (M3₄).

As is well known in the art, sintering additives may be added to the first and/or the second material M1, M2 in order to improve its properties. The amount of additives may be approximately up to 10% of the amount of first and/or second material.

The invention also relates to a method for producing a crack-free metal/ceramic FGM shape 1 as shown in FIG. 2. More specifically the invention relates to a stainless steel/alumina FGM, for thermal and wear resistance applications. It comprises the following steps:
1) Forming a FGM shape 1, as seen in FIG. 2, wherein the base surface or first surface 1a is up to 100% of the first material M1, preferably SUS316L (M1₃), the top layer or second surface 1b is up to 100% of the second material Al₂O₃ (M2₁), and the intermediate graded region has several composite interlayers n₁, n₂, . . . , nₙ, together creating an intermediate graded composite region 1c, essentially consisting of an intermix of the first M1, second M2 and third M3 material, preferably SUS316L. (M1₃), Al₂O₃ (M2₁) and a toughening additive. The toughening additive can for example be yttrium-stabilized zirconia, ZrO₂(3Y) (M3₂).
2) The starting Al₂O₃ (M2₁) powder is of high purity and has an average particle size of about 100 nm.
3) The compositions throughout the FGM interlayers n₁, n₂, . . . , nₙ in the intermediate graded composite region 1c are determined using a modified rule-of-mixture power law equation where the local volume fraction of the stainless steel, Vᵢ, in each interlayer is calculated as follows:

$${V}_{i} = [ 1 - {( \frac{i}{n + 1} )}^{P} ] \qquad ( 2 )$$

where i is the number of an interlayer, n is the total number of interlayers, and P is a material concentration exponent meaning how the concentration of the metal gradually changes through the n interlayers. Herein, a linear compositional profile (P=1) is selected which provides a metal composition change by 5 vol % per interlayer through 19 interlayers.
4) ZrO₂(3Y) (M3₂) is added in all composite interlayers n₁, n₂, . . . , nₙ in a certain ratio of the Al₂O₃ (M2₁) volume.
5) The ingredients of each composite interlayer are automatically or manually weighed and mixed, by dry mixing or wet mixing, until homogeneity, and if necessary dried and sieved.
6) The mixtures of all layers are loaded in order, layer by layer, into a sintering tool called die, preferably consisting of graphite and normally of a cylindrical shape. The whole die is then pre-pressed by cold uniaxial pressing.
7) The sintering is carried out by the spark plasma sintering technique (SPS).

It is also possible to use a different method to create the FGM shape. Here no pre-prepared interlayers of a mix between the first, second and third materials is used and loaded layer by layer. Instead the fine graded powders of the three materials are delivered continuously into the die in which the material is sintered forming the shape. The compositions throughout the FGM shape are for example determined using the modified rule-of-mixture power law equation.

Commercial submicron or micron-sized Al₂O₃ powders (M2₁) are usually sintered in the temperature range 1400°-1700° C. Herein, the present Al₂O₃ powder is pure and fine-grained. Preferably the grain dimension is of such a small diameter compared to conventional powders of micrometer size that the sintering temperature of the material is influenced. In the present invention the grain dimension in the M2 powder is of nano-size and has an average particle size of about 100 nm. This enables making the sintering at a sintering temperature as low as 1100° C. by the SPS method.

The sintering may also be performed in a non-cylindrical die or sample holder having a larger diameter towards the shape surface with the material having the lowest sintering temperature and vice versa. This enables different sintering temperatures of the three different materials, but the sintering may still be performed at the same sintering unit settings.

In this invention, the use of ZrO₂(3Y) as third material M3 is believed to be beneficial to decrease the thermal expansion mismatch between the interlayers and also improve the strength of the matrices especially at the ceramic-rich region because it has an intermediate coefficient of thermal expansion (α_{ZrO2≈}10×10⁻⁶/° C.), large bending strength (˜900 MPa) and high fracture toughness (˜13 MPa·m^{1/2}).

However, other materials with a coefficient of thermal expansion α3 intermediate between the coefficient of thermal expansion α1 for the first material M1 and coefficient of thermal expansion α2 for the second material M2, with a large bending strength superior to the bending strength of the second material M2 may also be used.

Al₂O₃ has low bending strength (˜250 MPa) and fracture toughness (˜4 MPa·m^{1/2}) and it is difficult to survive defect-free from the levels of residual stresses that may develop in the SUS316/Al₂O₃ FGM material system during the cooling after the sintering. In the ceramic-rich region, ZrO₂(3Y) will reduce the unit volume of Al₂O₃ and can provide internal restrains that significantly reduce the magnitude of the volume shrinkage during the cooling. ZrO₂(3Y) also works as tough blocking aggregates which can strengthen the Al₂O₃ phase and impede the initiation Of thermally induced micro-cracks.

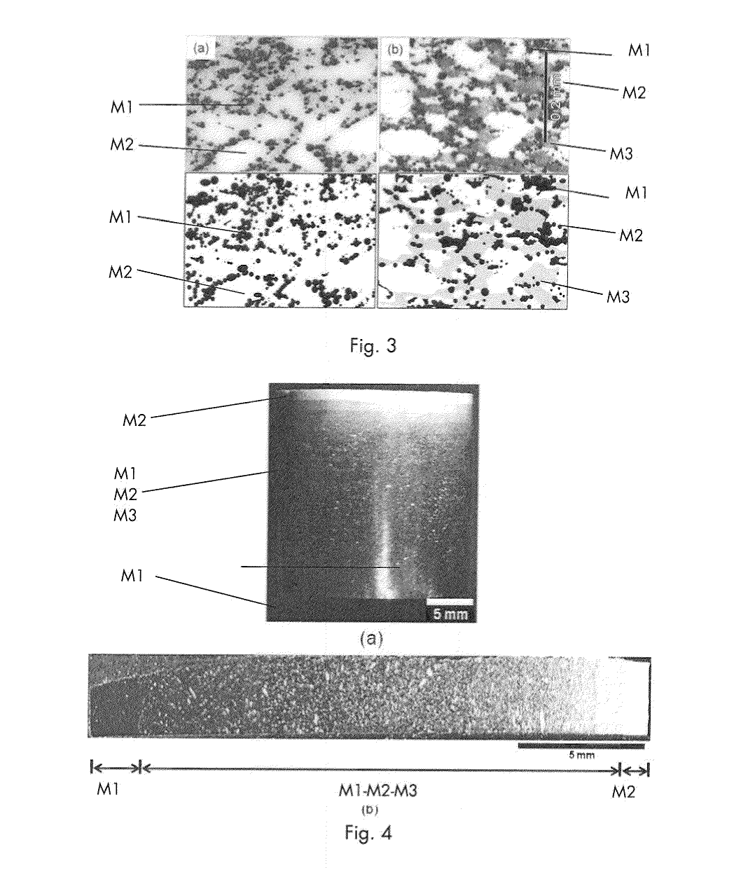

FIG. 3 shows a comparison between the microstructure of: (a) a known mixture of the first and second material M1, M2, more specifically 30% SUS316L-70% Al₂O₃ and (b) the inventive mixture between the first, second and third materials M1, M2, M3, more specifically 30% SUS316L-38.5% Al₂O₃-31.5% ZrO₂(3Y) composite layers. The black particles are grains of the first material M1, more specifically SUS316L grains, the white region is the second material M2, more specifically an Al₂O₃, and the grey is the third material M3, more specifically a ZrO₂(3Y). As can be seen, the third material, ZrO₂(3Y) stops the continuity of the second material, Al₂O₃ matrix and forms like tough blocks in the matrix.

The invention provides a new method to fabricate a crack-free functionally graded material according to the above, and according to the example herein. The FGM in the present invention comprises two dissimilar materials M1, M2 with large thermal expansion mismatch.

### EXAMPLE

A cylindrical-shaped FGM shape 1 of the first material M1, more specifically SUS316L and the second material M2, more specifically Al₂O₃, was prepared and is disclosed in the optical photograph in FIG. 4 showing: (a) the bulk dense FGM shape 1 with the different materials M1, M2, M3, and (b) the multilayers structure containing layers of different mixtures of the first, second and third materials M1-M2-M3. 21 different powder mixtures were prepared with the following compositions:

TABLE 1

| | Vol % | | |
|---|---|---|---|
| Layer | M1- SUS316L | Vol % M2- Al₂O₃ | Vol % M3- ZrO₂ (3Y) |
| 1 | 100.0 | 0.0 | 0.0 |
| 2 | 95.0 | 2.7 | 2.2 |
| 3 | 90.0 | 5.5 | 4.5 |
| 4 | 85.0 | 8.3 | 6.8 |
| 5 | 80.0 | 10.9 | 8.9 |
| 6 | 75.0 | 13.7 | 11.2 |
| 7 | 70.0 | 16.5 | 13.5 |
| 8 | 65.0 | 19.3 | 15.8 |
| 9 | 60.0 | 22.0 | 18.0 |
| 10 | 55.0 | 24.7 | 20.2 |
| 11 | 50.0 | 27.5 | 22.5 |
| 12 | 45.0 | 30.2 | 24.7 |
| 13 | 40.0 | 33.0 | 27.0 |
| 14 | 35.0 | 35.8 | 29.3 |
| 15 | 30.0 | 38.5 | 31.5 |
| 16 | 25.0 | 41.3 | 33.8 |
| 17 | 20.0 | 44.0 | 36.0 |
| 18 | 15.0 | 46.7 | 38.2 |
| 19 | 10.0 | 49.5 | 40.5 |
| 20 | 5.0 | 52.3 | 42.8 |
| 21 | 0.0 | 100.0 | 0.0 |

The 21 different mixtures were prepared through manual mixing of the dry powders of the first material M1 SUS316L (Micro-Melt® type 316L, D₉₀<22 μm, from Carpenter Powder Products Inc, USA), Al₂O₃ (100 nm, TM-DAR Taimei Chemicals Co., Ltd., Japan) and/or ZrO₂(3Y) (Grade TZ-3Y, Tosoh Corporation, Japan). The mixtures were loaded in order layer by layer in a graphite die and then the die was closed by two graphite rods referred to as punches. The FGM sample was sintered in a SPS unit (SPS-5.40 MK-VI system from SPS Syntex Inc Japan) and the temperature was initially automatically raised to 600° C. Subsequently, a heating rate of 100° C. min⁻¹ was applied. The sample was densified at 1100° C. for 30 minutes. The temperature was measured with an optical pyrometer focused on the surface of the sintering die. The sintering took place in vacuum. The SPS pressure was kept at 75 MPa. The FGM shape was produced as a cylinder with a diameter of 20 mm and a height of 22 mm.

The bulk dense FGM shape and the layers were free of cracks as seen in FIGS. 4(a) and (b), respectively. The relative density of the FGM shape is ˜95% of the theoretical value, as measured by Archimedes' method.

1. A functionally graded material shape, where a first material, which is a metal or metal alloy, is fused with a second material, which is a ceramic material, a metal or a metal alloy, through sintering, said first material has a first coefficient of thermal expansion (α1) and said second material has a second coefficient of thermal expansion (α2), differing from the first coefficient of thermal expansion, characterized in that the shape further comprises a third material adapted to create an intermediate composite material phase intermixed between the first and the second materials, said third material is a metal or a ceramic additive and has a coefficient of thermal expanion (α3) intermediate between the first coefficient of thermal expansion (α1) of the first material and the second coefficient of thermal expansion (α2) of the second material.

2. A functionally graded material shape according to claim 1, wherein the first, second and third materials sinter at approximately the same sintering temperatures, or where the first, second and third materials sinter at approximately the same sintering unit settings.

3. A functionally graded material shape according to claim 2, wherein at least one of the materials have grain dimensions of such a small dimension compared to standard powders of micrometer size that the sintering temperature of the materials is influenced.

4. A functionally graded material shape according to claim 3, wherein a nano-sized powder is used in at least one of the materials.

5. A functionally graded material shape according to claim 1, where the first material is stainless steel, nickel, nickel alloy or copper alloy and the second material is a ceramic material.

6. A functionally graded material shape according to claim 1, where the first material is stainless steel SUS 316/316L, SUS 304/304L, SUS 310/310S, SUS 405, SUS 420, Duplex stainless steel 2205, nickel, nickel alloy or copper alloy and the second material is aluminium oxide.

7. A functionally graded material shape according to claim 1, wherein the third material is a metal or a ceramic additive chosen from any of the materials yttrium-stabilized zirconia, ZrO₂(3Y), chromium, platinum or titanium.

8. A method producing the functionally graded material shape of claim 1 where the production method is spark plasma sintering (SPS).

9. A method for producing a FGM shape with one surface comprising up to 100% of a first material which is a metal or metal alloy and a second surface comprising up to 100% of a second material, which is a ceramic material, a metal or a metal alloy, comprising the steps: (i) selecting the first material and the second material with a first and second coefficient of thermal expansion (α1, α2) different from each other, (ii) adding a determined amount of a third material which is a metal or a ceramic additive or a ceramic toughening additive with an intermediate coefficient of thermal expansion (α3) intermixing with the first and the second materials and creating an intermediate region comprising the inventive functionally graded material of claim 1, (iii) adding at least one layer between the first surface and the second surface creating an intermediate graded composite region, and (iv) sintering the whole shape using spark plasma sintering (SPS).

10. Method according to claim 9, wherein the intermediate graded composite region has several interlayers essentially consisting of different mixtures of the first, second and third materials.

11. Method according to claim 9, wherein the first, second and third materials are delivered continuously into a die in which the material is sintered creating at least one interlayer with gradual variation in composition, smoothly or stepwisely, throughout the FGM shape consisting of different mixtures of the first, second and third materials.

12. Method according to claim 10, wherein the compositions throughout the at least one interlayer are determined using an equation where the local volume fraction of the first material, Vᵢ, in each interlayer is calculated as follows:
$${V}_{i} = [ 1 - {( \frac{i}{n + 1} )}^{P} ] \qquad ( 2 )$$
where i is the number of interlayer, n is the total number of interlayers, and P is a material concentration exponent.

13. Method according to claim 12, wherein the third material is added in at least one of the composite interlayers in a certain ratio of the volume fraction of the second material.

14. Method according to claim 9, where sintering takes place at a temperature of 1000-1200° C., preferably 1100° C., under a pressure of 50-100 MPa, preferably 75 MPa, for a holding time of 10-40 min, preferably 20-30 min, by spark plasma sintering.

15. Method according to claim 1, wherein at least one of the composite interlayers are composed of a first material of metal or metal alloy, chosen from one of stainless steel SUS 316/316L, SUS 304/304L, SUS 310/310S, SUS 405, SUS 420, Duplex stainless steel 2205, nickel, nickel alloy or copper alloy, a second material of ceramic, chosen from one of alumina, molybdenum disilicide or tungsten carbide, and a third material of a metal or a ceramic additive, chosen from one of zirconia(3Y), chromium, platinum or titanium.
